(19) United States
(12) Patent Application Publication
(10) Pub. No.: US 2004/0086838 A1
(43) Pub. Date: May 6, 2004

(54) Scuba diving simulator

(76) Inventor: Alain Dinis, Noisy le Roi (FR)

Correspondence Address: FRELING E. BAKER, BROWN MARTIN HALLER & MCCLAIM, 1660 UNION STREET, SAN DIEGO, CA, 92101, US

(21) Appl. No.: 10/440,856

(22) Filed: May 19, 2003

Related U.S. Application Data
(60) Provisional application No. 60/423,661, filed on Nov. 5, 2002.

(51) Int. Cl. G09B 9/00; G09B 19/00; A63B 69/00

(52) U.S. Cl. 434/247

(57) ABSTRACT

A diving simulator system, includes an interactive submersible diver apparatus having a computer monitor and user input control, a source of selectable underwater three dimensional virtual images and information relating to a diving site, and a computer interconnected between the source and the diver apparatus and programmed to selectively present diving site images and information to the apparatus in response to user input.

### REFERENCE TO RELATED APPLICATIONS

This application claims the benefit of U.S. Provisional Application 60/423,661, filed Nov. 5, 2002.

### BACKGROUND OF THE INVENTION

1. Field of the Invention

The present invention relates generally to underwater diving instruction, and pertains particularly to a computerized scuba diving simulator that recreates the specific conditions of scuba diving activities in a secure sub aquatic environment.

2. Description of the Prior Art

Scuba diving is a sport and a leisure that interests some forty million people around the world. Nevertheless, the access to this activity is not easy and, compared with other outdoor sports such as ski or sailing, scuba diving facilities have, generally, a less efficient organization. Families and youngsters find difficult to get starting into practice. At present such practice is carried out mainly at seashore diving sites, thus the opportunities for easy and secure learning, are relatively limited to most of the world population. This constraint is a main obstacle to the spread of this sport. Further, this situation reduces the frequency of the practice, and thereby increases the sports risks.

Beginners usually start learning scuba diving in a swimming pool close to the scuba diving site, under the surveillance of an instructor. They learn, in particular, how to operate scuba diving equipment, to swim under water breathing air from the tank, to control their stability and modify their depth, playing with diving stabilisers. Two or three days later, they realize their first dive at the site, always under the surveillance of an instructor.

During this first period of practice, the information on local conditions facing the beginner is, in general, either incomplete or too diverse to be retained in a short period of time. Difficulties related to the organisation of the scuba diving sites, to logistics of the activity or to communication problems, may render this first experience disappointing.

By the end of a week, the diver will have done only a few hours of scuba diving. In a majority of cases, he will only be able to repeat such dive training, once or twice a year. Under such conditions, the practice of scuba diving will be available to a minority of persons, living close to the sea, with considerable leisure time available.

More and more children are interested in the submarine world and the richness and beauty of its fauna. Millions of children, between ages 6 and 8, practice snorkelling, generally without any training program. When these children reach the age of about 10, they are allowed to start scuba diving. There are no training methods assuring a smooth and progressive transition from snorkelling to scuba diving. If such training was available, it would enable these children to join their parents that practice scuba diving and do such activity in family.

Presently, the learning of scuba diving techniques is generally done with the help of instruction manuals and, more recently, with videos or CD's-rom. The efficiency and the attractiveness of this method may be questioned, in particular for youngsters and beginners. The operation of scuba diving equipment, which is getting sophisticated and complicated, requires more than the study of these manuals. Essential aspects of scuba diving, such as decompression procedures, air mixes, instrument monitoring, require more realistic and measurable hands on learning methods. Repetition, and therefore time, is required for vital reflexes to be acquired by divers. The present procedures of training do not provide such opportunity.

The knowledge of diving sites is only acquired during successive dives because there is very little information about the submarine topography of sites, recommended itineraries and areas where interesting species of flora and fauna may be found. There are very few two dimensional maps with sufficient detail to enable divers to study and get acquainted with sites before doing their first dive. This situation favours improvisation and therefore increases the risk factor of this activity. It would be useful and desirable to have three dimensional representations of these sites to facilitate their understanding.

For confirmed and experienced divers, other than the actual dive in a site, there are no easy ways to practice periodically, to get into shape or to test their own physical resources. Unless they frequently visit the same site, they will not be able to memorize its different aspects and specificities. Such recurrence can't be achieved in most cases.

Underwater gymnastics and underwater therapy are also activities developed in pools requiring training, practice and instructor's supervision. As such, they present similarities with some tutorial aspects of snorkelling and scuba diving. Duration and recurrence of these activities, are important. There is also a need for simple and effective learning methods such as can be displayed as multimedia programs, preferably during the actual subaquatic practice.

Concerning professional and industry divers, performing underwater tasks such as inspections or repair work, no references were found of computer monitors being used by divers underwater, to communicate or to receive instructions and information from their supervisors at surface or from specialists located at distant locations, through the internet.

There is a need for an easy and proved system to connect such divers, performing difficult sub aquatic assignments, with those that conceive, monitor and control these operations, independently of their respective locations.

Consequently, there is a need for a scuba diving simulating system which can be used by scuba divers to learn, communicate, train and practice, with an instructor and as frequently as possible, in a secure and nearby aquatic place, virtually perceived as an actual diving site, while being capable to monitor their progress. This need is evident for beginners that find it difficult to get initiated on the scuba dive activities and cannot make appreciable progress due to the lack of opportunities. But it is also noticeable with more experienced divers, that dive once or twice a year, barely during a week, and would like to rehearse and practice more regularly, to keep in shape.

More generally, there is a need for computerized underwater visual display of information and communication systems, either for specific subaquatic diving simulations or for underwater instruction, training or entertainment.

### BRIEF SUMMARY AND OBJECTS OF THE INVENTION

It is the primary object of the present invention to the above and other problems of the prior art.

In accordance with a primary aspect of the present invention, a diving simulator system, comprises an interactive submersible diver apparatus having a computer monitor and user input control means, a source of selectable underwater three dimensional virtual images and information relating to at least one diving site; and a computer interconnected between said source and said diver apparatus and programmed to selectively present diving site images and information to said apparatus in response to user input.

### BRIEF DESCRIPTION OF THE SEVERAL VIEWS OF THE DRAWINGS

The above and other objects and advantages of the present invention will become apparent to those of skill in the art from the following description when read in conjunction with the accompanying drawings wherein:

FIG. 1 is a front elevation view of a scuba diving simulator system in accordance with one embodiment of the present invention.

FIG. 2 is a perspective illustration of the scuba diving apparatus of the system with a fully equipped diver practicing in a pool.

FIG. 3 is a detailed view of the divers control and monitoring apparatus.

FIG. 4 is a like FIG. 3, of an alternative embodiment of the divers control and monitoring apparatus.

FIG. 5 is an elevation view of the diver apparatus being used in a snorkelling mode.

FIG. 6 is an elevation view of the diver apparatus being used with a flexible breathing tube connected with the air tank attached to the column.

FIG. 7 is an elevation view of the diver apparatus being used by a diver in a scuba mode.

FIG. 8 is an elevation view of a diver operating the apparatus with an accessory that generates counter-currents opposed to his movement.

FIG. 9 is a plan view of the diver and apparatus of FIG. 8.

FIG. 10 is a perspective illustration of the scuba diving apparatus with a diver practicing in a pool having the floor modified to generates special water currents.

FIG. 11 is a perspective illustration of the scuba diving apparatus with a diver supported on a platform allowing him to follow the movements of the control and monitoring apparatus with both hands free.

FIG. 12 is a perspective illustration of another embodiment of the diving apparatus having a second monitor, allowing the instructor to see the same images as the diver.

FIG. 13 elevation view of a further embodiment wherein the control and monitoring apparatus detached from the column and floating under the water, on neutral buoyancy, thus giving to the diver that holds it, the freedom to move in any direction.

FIG. 14 is an elevation view of still another embodiment of the invention for operation in open sea where the control and monitoring apparatus is suspended and guided by cables attached to the instructor's boat.

FIG. 15 is an exemplary schematic display as seen by the diver on his monitor, showing a virtual image of his diving site, his itinerary, his location, incoming messages and data from his diving instruments.

FIG. 16 is an exemplary schematic display as seen by the instructor on his computer monitor, showing a virtual image of the diving site and diver's progression, the image of the diver in real time, messages and data from diving instruments.

FIG. 17 is a perspective illustration of a still further embodiment wherein the control and monitoring apparatus is installed on a stand equipped with a computer and connected with the internet for use as an interactive kiosk or as an arcade game machine.

FIG. 18 is flow chart of a typical virtual reality dive with a system of the present invention.

### DETAILED DESCRIPTION OF THE INVENTION

The present invention concerns a scuba diving simulator that integrates the new technologies of information and communication, such as for instance, interactive 3D modelling of the sub aquatic and developments of computerized internet systems for underwater applications.

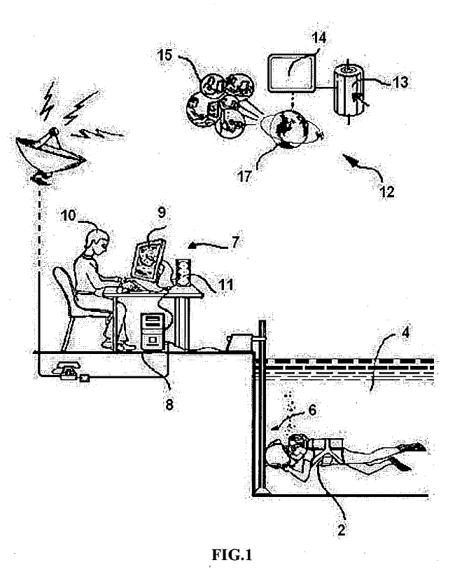

Referring to FIG. 1 of the drawing, a system in accordance with one embodiment of the invention is illustrated. The system comprises three main components or modules as will be more fully discussed. As illustrated, a diver 2, suitably equipped for scuba diving, is shown submerged within a body of water 4 such as a pool and holding onto and viewing a control and monitoring apparatus hereinafter called diver's unit, of a scuba diving apparatus designated generally at 6. The divers apparatus is the first described major component or module of the system and is adapted to be mounted in a body of water for use by a diver in training as will be discussed.

The diver apparatus is connected to the second major component or module, designated generally at 7, which comprises a computer system comprising a computer terminal 8 equipped with a monitor 9 which is used by an instructor 10 in the instruction and training of the diver. The computer system is configured and programmed to cover all tutorial aspects of diving technique, including its safety. This program and information may be provided on or from any suitable data recording or storage unit or device such as recorded on a hard drive or CD device 11 and available to the instructor.

Computer terminal 8 is also preferably connected in any suitable manner to a central information system, designated generally at 12, or other sources of data and information which constitutes the third major component or module of the invention. The connection may be any suitable connection such as through the Internet, schematically represented by a globe 17, to central information system 12. Central information system 12 preferably includes or comprises a Web site 14 having a central processing unit 13. The central information system provides access by the diver and instructor to all information necessary to recreate, actually and in real time, a diving site simulation. The diver or his instructor, through the Internet connection, can check and obtain update information from other net surfers, in particular, those of the divers community 15.

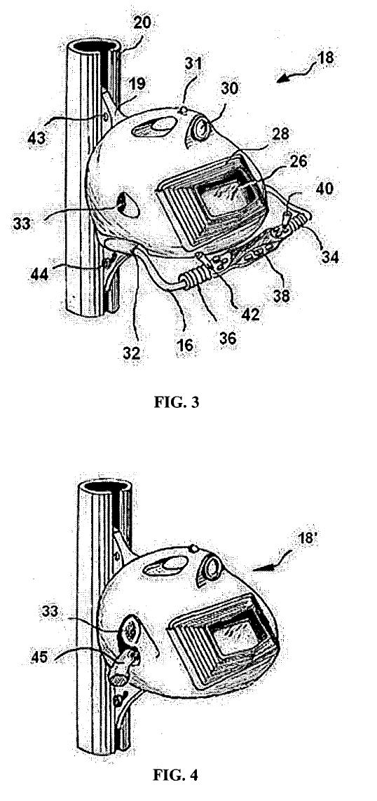

Turning now to FIG. 3 a perspective view of a diver apparatus mounted in and attached to the edge of a pool containing body of water 4 is illustrated. The diver apparatus comprises a diver's unit 18 mounted on a bracket 19 of an elevator device with a vertically oriented track 20 that functions to raise and lower the divers unit under the control of the diver or his instructor. The elevator is preferably constructed similar to that of a garage door opener and has drive means such as a screw, drive chain or hydraulic ram to drive the bracket along the track to selected levels in the body of water. The track is formed as a tube that may be circular or rectangular in cross section and has slot extending the length thereof in which bracket 19 is mounted and connects to the drive screw or the like mounted within the tube. Power such as an electric motor for operating the drive means of the track is enclosed in a housing 22 mounted on a deck adjacent the pool or body of water. The track has a telescoping construction with an extension 23 at the lower end to adjust to the depth of the body of water and has a base 24 to support it on the bottom of the pool.

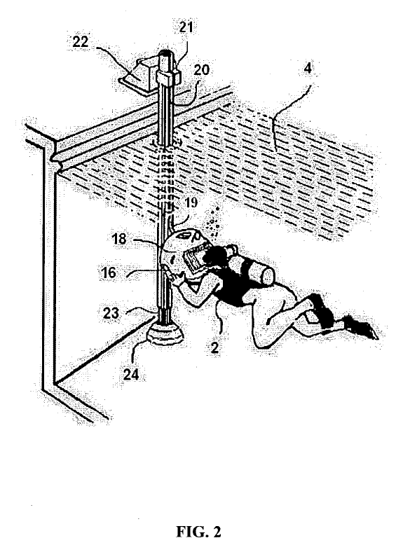

The diver's unit is basically a computer terminal or game controller encased in a watertight housing that is preferably substantially spherical in configuration and contains a control bar or handlebar 16 containing control knobs, switches and buttons that the diver manipulates to enables him to view instructions and messages from an instructor, select various scenes and to select and view various gauges and indicators. The switches and controls in clued the control functions of a mouse as well as switches to raise and lower the divers unit. Diver 2 is equipped with scuba gear and is viewing training information or data such as scenes of a site on a diver's unit 18. FIG. 2 illustrates a diver 2 submerged in water body 4 viewing a computer monitor and practising scuba diving.

The motor and other mechanisms, as well as the electric components of the drive means, are encased in the watertight housing or box 22, placed above the water level, and fixed on the deck adjacent the pool. The diver's unit 18 can be easily detached and preserved out of water, after the diving session.

The installation of these elements is carried out by introducing the column or track 20 into a circular opening in a bracket 21 of housing 22. Before lowering the column in the water, the base 24 is attached. Once lowered, the column and its base rest on the bottom of the pool. Bracket 19 of diver's unit 18 is then introduced from the top of the column and attached to the driving device of the column or track.

FIG. 3 illustrates a more detailed perspective view of the diver's unit 18. The housing of monitor 18 is constructed of a suitable material such as a metal or plastic and is preferably substantially hemispherical shape. It is watertight and resistant to water pressure. A computer monitor is mounted within the housing with screen 26 positioned at one side for viewing by a user. A flexible and detachable truncated eyeshade 28 is mounted over the screen to shield the screen and aid in viewing the screen. Alternative shaped eyeshades may be provided for the screen. At least one video camera 30 is mounted in the housing and positioned to view the diver.

An emergency xenon strobe 31 is preferably provided on the housing to enable the diver to signal in case of an emergency. A control bar 16 has a substantially U shape and is attached at each end to the housing by of a sensor device 32 that senses pressure or movement of the control bar relative to the housing. The sensors are calibrated and connected to controls operating through the computer that control the speed of the computer presentation of the path through the diving site so that pressure on the control as the result of swimming action by the diver controls his apparent speed through the site. Thus the force on the bar is converted to an equivalent speed of the diver through the water. Two underwater loudspeakers 33, only one shown, are mounted on the sides of the housing to enable audio communication with the diver.

Control bar 16 is provided with hand grips 34 and 36 where the diver grasps the control bar during his diving operation. A pair of joy sticks 40 and 42 are mounted on the control bar adjacent the hand grips for easy access by the diver. A control panel 38 having control knobs, switches and buttons is mounted in a center portion of the control bar between the hand grips. This positions all of the controls for easy access by the diver. This control arrangement enables the diver to grasp the bar with one hand and input control to selected ones of the many controls with the other. The control bar is sealed against water such as by being covered by a synthetic rubber film ensuring a watertight sealing.

In the connection 32 of the control bar with the control unit housing are sensors which measure the force that the diver applies on the handlebar when he engages in a swimming action. The sensors convert such force to an equivalent speed of the diver in the water.

The diver generally holds both handles 34 and 36 of the control bar 16. When necessary for the operation, he can grip only one handle and use the other hand to operate the different control switches and knobs to initiate selected commands. These commands control various functions of the computer and of the software, like that of a computer mouse, and of the apparatus, such as the vertical movements, the counter-currents and warning systems. Diver's unit 18 is fixed to the tubular column 20 on a horizontal pin 43 and on an adjustable knob 44 which allows the viewer to rotate and adapt to different angles of vision of divers.

FIG. 4 is a detailed perspective illustration of an alternate embodiment of the diver's control unit. This embodiment differs from the FIG. 3 embodiment in that the divers controls are embodied in a pair of joy sticks, only one of which 45 is shown, mounted on opposite sides of the housing. These are mounted to the diver's unit 18′ in articulating sensors as in the prior embodiment so that movement of the joy sticks translates signals to the computer that controls the system. Command and control buttons, knobs and switches similar to those on panel 38 are mounted on each of the joy sticks for enabling the diver to manipulate and control the many aspects of the system.

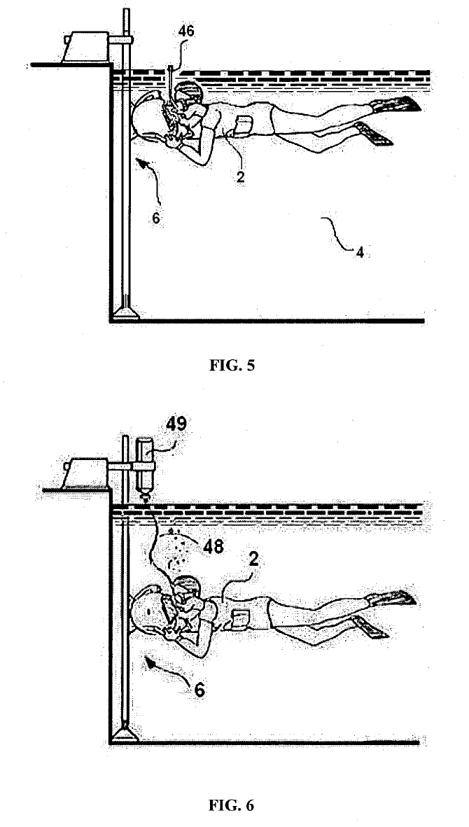

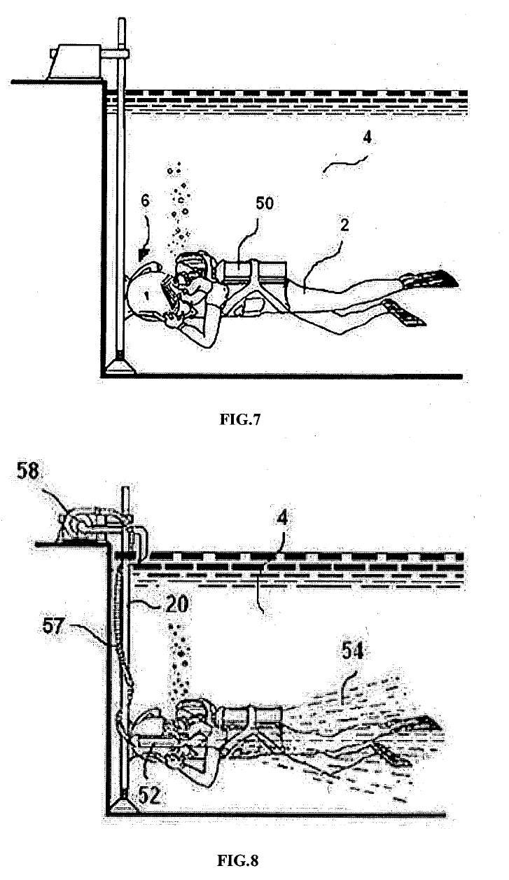

FIGS. 5 through 7 illustrate progressive stages in the training of a diver from beginning at FIG. 5 to ready for un-tethered diving in FIG. 7. FIG. 5 shows a side elevation view of the diver apparatus with the diver control unit positioned at the minimum depth of immersion, for enabling the diver to engage in the practice of snorkelling. As illustrated diver 2 is equipped with a snorkelling tube 46, and diving just under water surface, in a water body 4, using the basic diver apparatus 6. This configuration, enables the simulator to be used in the snorkelling mode for early training. This is particularly suitable for training children, and ensures their progressive preparation for deep-sea diving. This enables progressive training under monitoring of an instructor with transition to air tanks and deep sea diving as soon as their age and skills allow them to do so.

FIG. 6 shows another mode of use of the invention with diver 2 equipped with a special flexible breathing tube 48 connected to an air tank 49 using the same diver apparatus 6. Tube 48 enables the diver to go down deeper in the pool, without carrying a tank or any other specific scuba equipment, this being a step further towards deeper diving. The tube is directly connected to air tank 49 fixed to the column, thus avoiding the need for the diver to carry it.

FIG. 7 illustrates the diver near the bottom of the water body in a condition such as in a final stage of training, with or on the simulator. As illustrated, diver 2 now fully equipped for scuba diving, including a tank 50 is shown at substantially the maximum depth provided by the body of water 4. The diver, using the diver apparatus 6 is now able to dive in scuba gear in pool of water body 4, without depth limitations other than that of the body of water. The diver then moves from this stage to a real diving site or environment. Vertical movement and positioning of the diver can be controlled by either the instructor or the diver by means of the drive of the diver apparatus. This movement simulates changes of depth along the diving course.

Referring now to FIGS. 8 and 9, another embodiment of the invention, in elevation and plan views respectively is illustrated. The diver apparatus is modified to include a water jet system to provide a flow of water toward the front of the diver to simulate a current opposing the divers direction of apparent movement. The apparatus comprises a semicircular jet or nozzle array having curved arms 52 and 56 mounted on the diver's unit and is supplied with pressurized water directed at the front of the diver. The nozzle array is mounted to move vertically with the diver's unit on track 20. A pump 58 driven by a suitable motor (not shown) draws water from pool 4 and directs it along a flexible line or tube 57 to the nozzle array 52 and 56. The nozzle array produces a pressure jet of water pumped from the swimming pool, simulating an underwater counter-current 54 opposed to the effort generated by the diver's fins and reducing diver's virtual speed in the water. The diver can vary the power of pumping, which determines the force of the current, can change its direction by operating the adjustable nozzles 56 and can adjust its temperature. The pumping system 58 as well as the devices that monitor the flow, the direction of the current or its temperature, are accessories added to the basic apparatus.

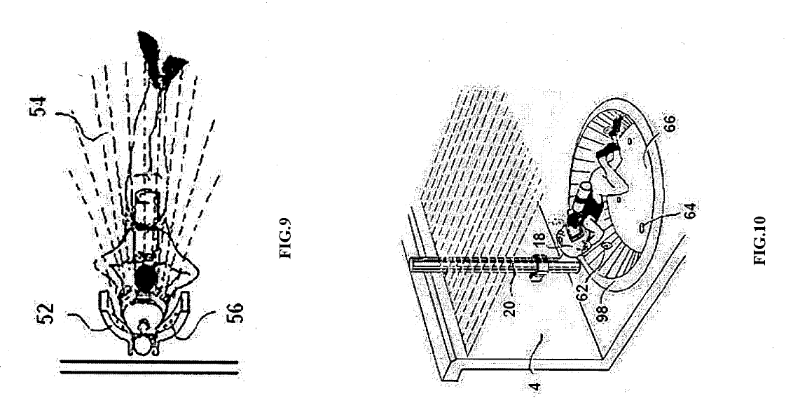

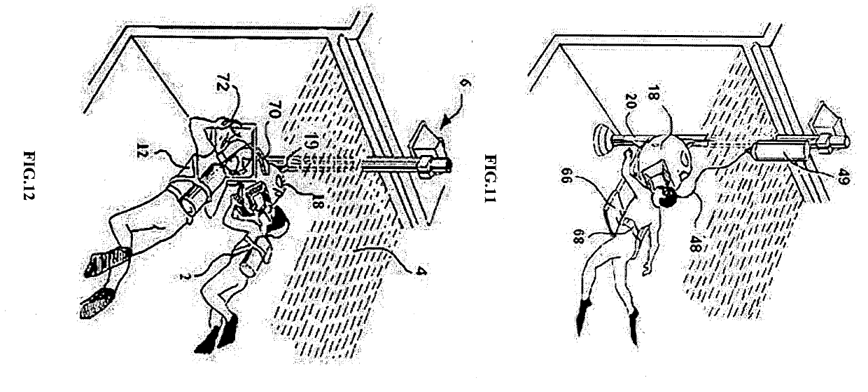

FIG. 10 illustrates a modification that incorporates a circular pit 66 having jets or nozzles 62 and 64 in the bottom of a pool 4. The pit can be used to increase the depth of the pool in the area where divers practice and also add jets to selectively create various currents in the water. The pit can be a pre-moulded pit unit 66 that is inserted in the floor of existing pools or integrated during the construction of new ones. This unit is equipped with a variable speed pump and with a system of high pressure adjustable nozzles 62 and outlets 64, monitored and controlled by the diver operating the controls on the control bar of the diver's unit 18. This system generates upwards, downwards or whirling currents inside the pit which effect may be combined with vertical movements of the monitor sliding on the column 20.

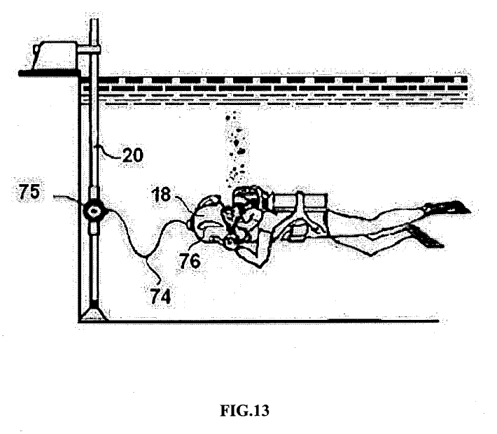

Referring to FIG. 11 another modification to the divers apparatus is illustrated wherein a support platform 66 is attached to the support bracket for the divers unit for supporting a diver that may be handicapped. This modification enables one to have both hands free as in the typical diving situation. It also enables one who may not have full use of his limbs to enjoy the simulation of diving. It provides means for the diver to be strapped to the support platform by a belt 68 and to have free use of the hand. This embodiment enables use of the invention for the practice of underwater gymnastics and for underwater therapy. The diver's body is supported by the platform or pad 66, to which he may be attached with a strap 68, so that he moves along with the diver's unit. A flexible tube 48 allows breathing directly from an air tank 49 fixed to the support column 20.

Another modification of the divers control unit is illustrated in FIG. 12 wherein an additional monitoring screen 72 is provided and attached by a bracket 70 to the diver's unit. This enables instructor 12 to enter the water and provide more direct instruction and supervision to the diver. The diver 2 and his instructor 12 are shown side by side in the pool 4, during the diving session with the apparatus 6. A hinged arm 70, which carries monitor 72 is connected to the diver's terminal or to bracket 19. This second monitor used by the instructor to assist and supervise the practice of the diver, is preferably connected to enable the instructor to interact with and receive the same images and information as the monitor of the diver. This scheme is particularly applicable to training of children or handicapped divers, when for safety reasons; the close presence of an instructor is desirable or required.

FIG. 13 illustrates another embodiment of the invention, wherein the diver's unit is detached from the column allowing diver greater movements in all directions in a body of water. As illustrated, the diver's unit 18 is detached from the column 20, and floats freely on neutral buoyancy, stabilized by accessory wings 76, with the diver holding the control bar. The diver's unit remains nevertheless connected with the column 20 and with the instructor's computer, by a flexible cable 74 containing the wiring, which can be automatically rewound by a take up reel or winding device 75 that the diver can command and control from his control bar.

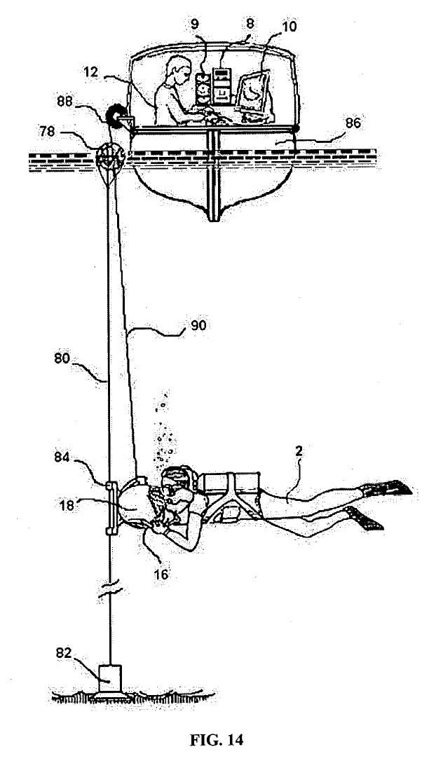

A modification of the system for open sea use from a boat is illustrated in FIG. 14. A buoy 78 supports the upper end of a tension cable 80 adjacent a boat 86. Cable 80 is anchored at its lower end by an anchor or weight 82 a the bottom of a body of water. A diver's unit 18 is mounted by a bracket 84 to slide up and down on the cable. A power winch 88 on boat 86 has a cable 90 attached to the diver's unit 18 for selectively positioning it at selected depths in the body of water. Cable 90 also preferably includes conductors for communicating between the instructors computer 8 on the boat and the diver's unit 18. This embodiment of the invention provides means for divers practising or rehearsing in open sea, generally before a first dive in or at a diving site. This configuration enables them, securely and under the monitoring of the instructor located in the boat, to get acquainted and familiarized with the water depths, water temperatures, visibility, underwater currents, in environments generally similar to the site or in the site itself. The instructor can monitor the activity of the diver, who by operating the commands on the control bar of his unit, can also communicate with the instructor.

Divers having followed the training and having practiced scuba diving in a pool with the simulator object of this invention can use this adaptation of the apparatus for scuba diving at selected sites at sea to enable further training or the like. This configuration of the invention allows divers, after completion of their course on the site, to initiate the ascent according to instructions transmitted by the instructor. For example, this preferably includes the stages of decompression, which instructions appear on the monitor of the divers unit.

Once the diving session is completed, the ascent of the diver takes place. As the diver holds the control bar of the unit which hangs from the retention cable, the winch may be used to raise the unit and the diver, together. Electric winch 88 can be provided with a reader and a command programming the ascent of the diver according to safe decompression steps. The ascent, one of the most critical phases of diving, would thus be carried out in full safety, with the necessary preparation and under control of both, the diver and his instructor.

This embodiment of the invention can be advantageously applied for testing of diving equipment, for rescue exercises and for training divers under risky or unfavourable conditions of water currents, visibility or accessibility.

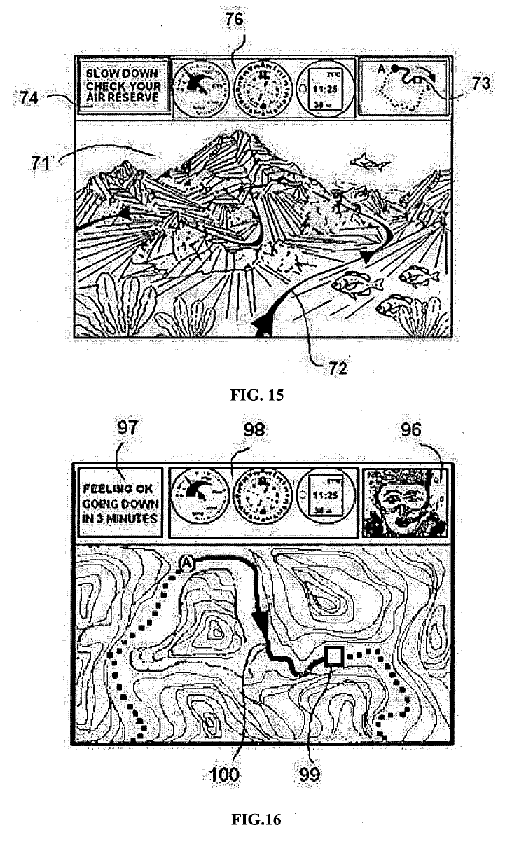

FIG. 15 illustrates an example of images the diver sees successively on the monitor of diver's unit. A 3D image or view 71 of the site where his diving session takes place, appears on the divers monitor, with the course selected as well as indications on the flora and fauna of the areas. The diver is shown to be at point 73 along the virtual course 72 in the upper right corner of the screen. Messages from the instructor appear in the window 74 at the upper left hand corner of the screen. The upper middle window 76 gives indications of diving instruments such as air reserves, time spent, remaining time, water depths and orientation.

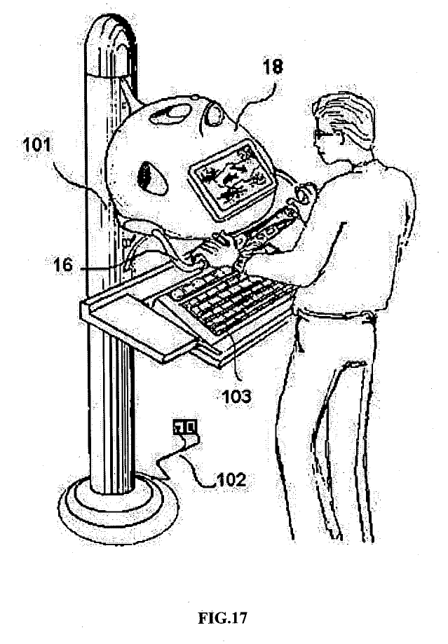

FIG. 16 illustrates an example of images the instructor sees appearing on his monitor. In the upper right hand window 96 the diver is continuously shown through the video camera installed on the diver's unit. In the upper left hand window 97 are messages from the diver. In the upper middle window 98 are shown the same indications from diving instruments as those of the diver's window 76. In addition, the instructor can follow and supervise the progression of diver, who is at location 99, along the course 100.

FIG. 17 is a perspective view of an alternate mode of use of the diver's unit of the invention. The diver's unit 18 is installed on a stand 101 connected by conductor 102 to the central information system either directly or through the internet.

Operating the control bar and the joysticks 16, the unit is used as a display of an arcade game machine or as a common monitor of an interactive kiosk, when equipped with a keyboard 103. This concept allows divers, before or after a diving practice, to prepare, rehearse or study information related to their next diving program or to their recent practice, out of water, but with the same apparatus used under water.

Although the preferred embodiments of the present invention have been principally shown and described as relating to a scuba diving simulator and, more generally as a underwater source of information, entertainment and as a sub aquatic multimedia terminal, the present invention could also be used, in another preferred embodiment, out of water, as an apparatus for arcade games or as an interactive kiosk.

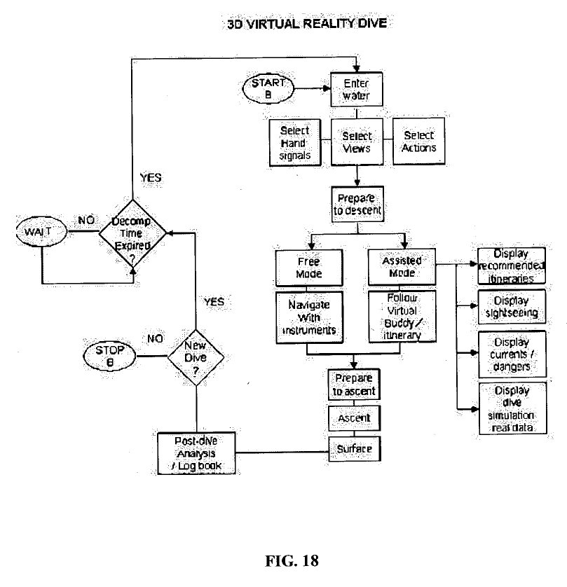

FIG. 18 is a flow diagram of a 3D virtual reality dive. The diver gets dressed and equipped for an actual scuba dive, with a wetsuit, BC jacket, tank, fins, mask and snorkel. He then enters the water and starts the session, selecting hand signals, views, and actions. He prepares to descend by grasping the control bar and begins a descent moving his fins as in a swimming mode.

During the session he will see, on the screen, the images of the site where he is realizing his virtual dive and where he will be following the selected itinerary. Using the different commands on his control bar, he will navigate in such virtual site combining sensory and mental impressions from images received from the central information system or the internet and from his operation of the divers unit, always in an immersed condition.

The impressions and feelings encountered are comparable to those of an actual dive at the site: he is totally immersed and weightless, he is fully dressed and equipped, breathing the air of the tank, he checks the different instruments and in particular the air pressure, he monitors his progression in the virtual site, controls water depths and speed of movement, enjoys the scenery, looks for different species of fauna and flora and, as required, operates the commands on the handlebar he keeps holding.

In his screen the diver will see the data of the diving instruments: time, pressure gauge, depth, orientation, itinerary followed, etc. He remains, during the complete session, under visual surveillance of the instructor with whom he is able to communicate. At the end of the session, the diver realizes the virtual ascent following the timing and procedures of decompression.

The system will record the data of the divers training session. This information combines virtual data such as distances and depths of the site, with real data such as duration and air pressures of the tank.

Once he has completed the session the diver gets out of water and analyses with the instructor the report of his dive. He will be able to study his performance, discuss with the instructor the different aspects of his diving session and compare with the information available from other divers.

The best scuba diving sites are far away, of difficult access, fragile and at risk, requiring urgent protective measures to remain alive. Instead of bringing growing numbers of unprepared divers to these sites, further aggravating their decay, the object of the present invention is to bring those sites, under virtual form and within a sub aquatic environment, as close as possible to divers' homes. Thus, these divers have the opportunity to learn, to understand and to get prepared, before their first dive at the site. The present invention accompanies divers during their initiation, follows them all along their progressive training and recurrent practice, until they overcome the challenge of diving in open sea sites.

Operated underwater, the scuba diving simulator offers easy, versatile and updated access to diving practices, combining virtual imagery with real diving sensations. It further enhances, with the attractiveness and pleasures of multimedia, the practice of aquatic gymnastics and underwater therapy. Used out of water, it extends the diving education or entertains as an arcade game machine or yet, offers the services of an interactive kiosk.

This invention may be used in different activities related to submarine environment, such as instruction, training and practice of scuba diving, access to information concerning the scuba diving sites and, more generally, to sub aquatic sports and leisure activities, marine education of young swimmers and divers, protection of the marine ecosystem, collection and transfer of information within the diving community through the internet. By extension it may be used for underwater exercises and therapy.

The apparatus of the present invention is adaptable to different aquatic locations such as swimming pools, diving pits, lakes, rivers and maritime locations, close to or comparable with, diving sites. Its modular structure, its lightness and transportability gives the required versatility and easy assembly. The depths of water in pools may vary from five to twelve feet and may reach one hundred fifty feet, for special diving pits and for diving sites.

Accessories or alternative components are provided to the basic apparatus to generate vertical movements, free diving on neutral buoyancy, counter-currents, to deepen shallow pools, for the instructor to accompany the diver, to allow the practice with free hands and for marine applications.

Before a diving session, the present invention enables the diver to plan and prepare himself for the diving. He can do this preparation at home, using his computer or he can do this at the training facility, using the instructor's computer. This preparation covers, for instance, the selection of a diving site anywhere in the world, where he wishes to practice and, in the site selected, the choice of the diving itinerary recommended for his diving background and experience.

The diver can realize a virtual visit of the site, in interactive 3D, and study the selected itinerary to get familiarized with the specific features and conditions of the course. He may consider the opinions of other divers on the site and on the itinerary. He may also review the instruction manuals and other technical data, before the dive, through the computer of the instructor and discuss with him the technical aspects of his diving plan.

While the present invention has been illustrated and described by means of various specific embodiments, it will be understood that various omissions, substitutions and changes in the form and details of the invention may be made by those skilled in the art, without departing from the spirit and scope of the invention as defined in the appended claims.

What I claim as my invention is:

1. A diving simulator system, comprising:
an interactive submersible diver apparatus having a computer monitor and user input control means;
a source of selectable underwater three dimensional virtual images and information relating to at least one diving site; and
a computer interconnected between said source and said diver apparatus and programmed to selectively present diving site images and information to said apparatus in response to user input.

2. A diving simulator according to claim 1, wherein the diver apparatus further comprises a video camera, an emergency xenon strobe, a control bar on which is mounted the input control means, and the computer monitor is equipped with an eyeshade.

3. A diving simulator according to claim 1, wherein the submersible diver apparatus further comprises support means mounting the video monitor for selectively positioning the diver's unit at selected vertical submerged positions.

4. A diving simulator according to claim 1, wherein the submersible diver apparatus further comprises a current generating device that injects water under pressure to create a counter-current opposed to the virtual displacement of the diver and means for monitoring the force, the direction and the temperature of said counter-current.

5. A diving simulator according to claim 4, wherein the current generating device includes a diving pit equipped with adjustable nozzles generating upwards, downwards or whirling jet currents.

6. A diving simulator according to claim 3, wherein the support means comprises:
a mounting and guide cable adapted for attachment to a boat and having an anchor for attachment at the bottom of a body of water, and for mounting the diver's unit;
a winch driven positioning cable for attachment to and selectively positioning the diver's unit at selected vertical submerged positions within a body of water.

7. A diving simulator according to claim 3, wherein the support means comprises:
an elongated guide track having first anchoring means at an upper end for mounting to a deck adjacent a pool and second anchoring means at a lower end for mounting to a bottom of a pool;
a carrier bracket mounted on said track for movement along said track;
attachment means for detachably mounting the diver's unit to said carrier bracket; and
drive means coupled to said carrier bracket for selectively positioning the diver's unit at selected vertical submerged positions within a body of water.

8. A diving simulator according to claim 2, wherein the said control bar includes two hand grips, a joy stick adjacent each grip and a control panel with a plurality of buttons enabling the operator to operate the apparatus, receive messages, images and information from the source and from an instructor, on said monitor.

9. A diving simulator according to claim 1, wherein the diver apparatus further comprises a video camera, an emergency xenon strobe, two joysticks, the joysticks having control buttons thereon enabling the diver to select images and information from the data source and from the instructor, on said monitor. A diving simulator according to claim 1, wherein said source of information and images comprises a data storage unit connected to said computer.

10. A diving simulator according to claim 1, wherein said source of information and images comprises a program on said computer (,) programmed to generate virtual images of diving sites.

11. A diving simulator according to claim 1, wherein said source of information and images comprises a Web site accessed via the internet.

12. A diving simulator according to claim 12, wherein said source of is a video camera at a selected diving site, that collects information and images and comprises a data storage unit connected to said computer.

13. A diving simulator according to claim 1, wherein the diver apparatus further comprises an attached instructor's computer monitor and related controls.

14. A diving simulator according to claim 1, wherein the diver apparatus further comprises a support platform for supporting a diver at a viewing level to said video monitor.

15. A diving simulator system, comprising:
an interactive submersible diver apparatus having at least one computer monitor and user input control means;
an elongated support structure for mounting in a body of water for selectively positioning the diver's unit at selected vertical submerged positions in the body of water;
a source of selectable underwater three dimensional virtual images and information relating to at least one diving site, the source selected from the group consisting of a computer memory record of at least one diving site, a computer programmed to generate a simulation of at least one diving site, and an internet connection to distribute the images of at least one diving site; and
a computer interconnected between said source and said diver apparatus and programmed to selectively present diving site images and information from said source to said apparatus in response to user input.

17. A diving simulator system according to claim 16, wherein the said diver apparatus further comprises a control bar including two hand grips, a joy stick adjacent each grip and a control panel with a plurality of buttons enabling the operator to operate the apparatus, receive messages, images and information from the source and from an instructor, on said monitor.

18. A diving simulator system according to claim 17 wherein the support means comprises:
an elongated guide track having first anchoring means at an upper end for mounting to a deck adjacent a pool and second anchoring means at a lower end for mounting to a bottom of a pool;
a carrier bracket mounted on said track for movement along said track;
attachment means for detachably mounting the diver's unit to said carrier bracket; and
drive means coupled to said carrier bracket for selectively positioning the diver's unit at selected vertical submerged positions within a body of water.

19. A diving simulator system according to claim 18 wherein the submersible diver apparatus further comprises a current generating device that injects water under pressure to create a counter-current opposed to the virtual displacement of the diver and means for monitoring the force, the direction and the temperature of said counter-current.

20. A diving simulator system according to claim 19 wherein the current generating device includes a diving pit equipped with adjustable nozzles generating upwards, downwards or whirling jet currents.

21. A diving simulator system according to claim 16 wherein the diver apparatus further comprises a video camera, an emergency xenon strobe, two joysticks, the joysticks having control buttons thereon enabling the diver to select images and information from the data source and from the instructor, on said monitor.

22. A diving simulator system according to claim 16 wherein the diver apparatus further comprises an instructor's computer monitor and related controls.
